(19) United States
(12) Patent Application Publication
(10) Pub. No.: US 2023/0311300 A1
(43) Pub. Date: Oct. 5, 2023

(54) Servo Motor and Robotic Apparatus

(71) Applicant: Futaba Corporation, Chiba (JP)

(72) Inventors: Shotaro KUDO, Chiba (JP); Toru KONO, Chiba (JP); Ryosei KURAMOTO, Chiba (JP); Hidetoshi MURAMATSU, Chiba (JP); Tomohiro KOMIYAMA, Chiba (JP); Yuri MIYAMA, Chiba (JP); Hideki OKU, Chiba (JP)

(21) Appl. No.: 18/022,711

(22) PCT Filed: Sep. 21, 2021
(86) PCT No.: PCT/JP2021/034534

§ 371 Date: Feb. 22, 2023

(30) Foreign Application Priority Data
Sep. 28, 2020 (JP) 2020-162046

(51) Int. Cl. B25J 9/12; H02K 11/33

(52) U.S. Cl. CPC B25J 9/126; H02K 11/33; H02K 2211/03

(57) ABSTRACT

A servo motor includes: a driving section including a rotor and stator; an input shaft configured such that a driving force of the driving section is transferred to the input shaft, wherein the input shaft is configured to be integral and rotated with the rotor; a reduction gear configured to output the driving force from the input shaft by reducing a rotational speed of the input shaft; an output shaft configured such that the driving force which has been transferred to the input shaft is transferred to the output shaft via the reduction gear; an input encoder disc attached to the input shaft; an output encoder disc attached to the output shaft; a circuit board including a predetermined circuit pattern; an input sensor mounted on the circuit board, wherein the input sensor is oriented toward the input encoder disc; and an output sensor mounted on the circuit board, wherein the output sensor is oriented toward the output encoder disc; wherein at least one of the input sensor or the output sensor is mounted on the circuit board via a spacer board, the spacer board being connected to the circuit board, and wherein an electronic component is mounted on the circuit board, the electronic component being different from the input sensor and output sensor.

### BACKGROUND OF THE INVENTION

### Technical Field

The present invention relates to technical fields of a servo motor with an encoder and of a robotic apparatus with such a servo motor.

### Background Art

There are servo motors including an encoder for detecting e.g., an individual rotational position and rotational angle of various parts. Such a servo motor is used in various types of structure, such as a robotic apparatus. Various types of robotic apparatus have been developed by improvement of automation in industries, and have different structures and performances e.g., depending on industrial application.

For example, there is a type of robotic apparatuses, so-called articulated robots, which include a plurality of assemblies for a robot for use as joints and/or arms for a robot, the assemblies being coupled to each other. Some articulated robots are configurable to be adapted e.g., for different applications, which is accomplished by changing a coupled state of the assemblies.

Encoders are used for various structures such as the above-mentioned robotic apparatus. Such encoders are configured so that e.g., a sensor mounted on a board is oriented toward an encoder disc, wherein the sensor detects a magnetic force generated in a magnet and/or a light emitted from a light source to detect e.g., a rotational position and/or angle of a rotor and/or various rotating bodies which are rotated together with the rotor (see e.g., Patent Document 1).

Patent Document 1 describes an example in which a magnetic encoder and an optical encoder are provided, wherein the optical encoder includes a light receiving section mounted on a board via a spacer, the light receiving section being configured to function as a sensor. The magnetic encoder is configured such that a distance between a magnet and a sensor is optimized while the optical encoder is configured such that between a distance an encoder disc and a sensor (light receiving section) is optimized.

### CITATION LIST

### Patent Literature

Patent Document 1: JP H02-090017 A

### SUMMARY OF THE INVENTION

Some servo motors including encoders as described above are configured such that an input shaft is integral and rotated with a rotor, a rotational speed of the input shaft is reduced by a reduction gear and a driving force of the rotor is transferred to an output shaft, wherein such a servo motor includes an input encoder and an output encoder which detect a rotation state of the input shaft and a rotation state of the output shaft respectively, e.g. in order to improve reliability of operation.

Such a servo motor includes an input sensor and an output sensor mounted on a circuit board, the input sensor and output sensor being configured to detect a rotational position of the input shaft and a rotational position of the output shaft respectively, wherein the input sensor is oriented toward an input encoder disc attached to the input shaft and the output sensor is oriented toward an output encoder disc attached to the output shaft. In this case, in order to ensure good detection by each of the sensors, respective positions of the circuit board and encoder discs are set so that the distance between each of the sensors and a corresponding one of the encoder discs is proper.

In order to efficiently utilize a mounting space of the circuit board and thus reduce the size of the servo motor, it may be desired to mount electronic components on a surface of the circuit board facing the encoder discs, wherein the electronic components being different from the sensors, such as a central processing unit CPU connected to the sensors and/or EEPROM (Electrically Erasable Programmable Read-Only Memory) which is non-volatile memory.

However, since the proper distance between each of the sensor and a corresponding one of the encoder discs is generally small to ensure a high detection performance of the sensors, only electronic components having a limited size (height) can be mounted, wherein this limitation may reduce flexibility of design and/or prohibit miniaturization.

Therefore, an objective which underlies a servo motor and a robotic apparatus according to the present invention is to enable an improved flexibility of design and miniaturization to be achieved.

In at least some embodiments of the present invention, a servo motor includes: a driving section including a rotor and stator; an input shaft configured such that a driving force of the driving section is transferred to the input shaft, wherein the input shaft is configured to be integral and rotated with the rotor; a reduction gear configured to output the driving force from the input shaft by reducing a rotational speed of the input shaft; an output shaft configured such that the driving force which has been transferred to the input shaft is transferred to the output shaft via the reduction gear; an input encoder disc attached to the input shaft; an output encoder disc attached to the output shaft; a circuit board including a predetermined circuit pattern; an input sensor mounted on the circuit board, wherein the input sensor is oriented toward the input encoder disc; and an output sensor mounted on the circuit board, wherein the output sensor is oriented toward the output encoder disc; wherein at least one of the input sensor or the output sensor is mounted on the circuit board via a spacer board, the spacer board being connected to the circuit board, and wherein an electronic component is mounted on the circuit board, the electronic component being different from the input sensor and output sensor.

In this manner, at least one of a distance between the input encoder disc and the input sensor or a distance between the output encoder disc and the output sensor is increased by an amount corresponding to positioning the spacer board, whereby limitations to sizes of electronic components which are mountable to the circuit board may be caused with less likelihood.

In at least some embodiments of the present invention, preferably, one of the input sensor or the output sensor is mounted on the circuit board via the spacer board.

This enables a distance to the circuit board from one of the input encoder disc or the output encoder disc to be increased depending on an internal structure of the servo motor.

In at least some embodiments of the present invention, the servo motor is preferably configured such that each of the input sensor and the output sensor is mounted on the circuit board via the spacer board.

This enables both of a distance between the circuit board and the input encoder disc and the distance between the circuit board and the output encoder disc to be increased.

In at least some embodiments of the present invention, the servo motor is preferably configured such that the input sensor and the output sensor are spaced or aligned radially with respect to a center of rotation of the input shaft.

This enables the input sensor and output sensor to be mounted in positions on the circuit board which are in vicinity of each other.

In at least some embodiments of the present invention, the servo motor is preferably configured such that the electronic component, the input sensor and the output sensor are spaced or aligned radially with respect to a center of rotation of the input shaft.

This enables the input sensor, output sensor and electronic component to be mounted in positions on the circuit board which are in vicinity of each other.

In at least some embodiments of the present invention, the servo motor is preferably such that the electronic component includes a component which forms a driver circuit at least partially, the driver circuit being configured to drive the driving section.

In this manner, the input sensor and output sensor are mounted on the circuit board while the electronic component includes the component which forms the driver at least partially, whereby the component which forms the driver circuit at least partially is mounted on the board including the input sensor and output sensor mounted thereon.

In at least some embodiments of the present invention, the servo motor is preferably configured such that a portion of an outer circumferential surface of the input shaft is configured as an input attachment portion to which the input encoder disc is attached, wherein a portion of an outer circumferential surface of the output shaft is configured as output attachment portion to which the output encoder disc is attached, and wherein at least one of the input attachment portion or the output attachment portion has a constant diameter in an axial direction.

This enables position adjustment of at least one of axial positions at the input attachment portion and at the output attachment portion in which the input encoder disc and the output encoder disc are attached, respectively.

In at least some embodiments of the present invention, a robotic apparatus includes: a plurality of assemblies for a robot; and a servo motor at at least one of the assemblies, the servo motor including: a driving section including a rotor and stator; an input shaft configured such that a driving force of the driving section is transferred to the input shaft, wherein the input shaft is configured to be integral and rotated with the rotor; a reduction gear configured to output the driving force from the input shaft by reducing a rotational speed of the input shaft; an output shaft configured such that the driving force which has been transferred to the input shaft is transferred to the output shaft via the reduction gear; an input encoder disc attached to the input shaft; an output encoder disc attached to the output shaft; a circuit board including a predetermined circuit pattern; an input sensor mounted on the circuit board, wherein the input sensor is oriented toward the input encoder disc; and an output sensor mounted on the circuit board; wherein the output sensor is oriented toward the output encoder disc; wherein at least one of the input sensor or the output sensor is mounted on the circuit board via a spacer board, the spacer board being connected to the circuit board, and wherein an electronic component is mounted on the circuit board, the electronic component being different from the input sensor and output sensor.

In this manner, at least one of a distance between the input encoder disc and the input sensor or a distance between the output encoder disc and the output sensor in the servo motor is increased by an amount corresponding to positioning the spacer board, whereby limitations to sizes of electronic components which are capable of being mounted to the circuit board may be caused with less likelihood.

With the present invention, at least one of a distance between the input encoder disc and the input sensor or a distance between the output encoder disc and the output sensor is increased by an amount corresponding to positioning the spacer board, whereby limitations to sizes of electronic components which are mountable to the circuit board may be caused with less likelihood, which may enable an improved flexibility of design and miniaturization to be achieved.

### BRIEF DESCRIPTION OF THE DRAWINGS

FIG. 1 shows, together with FIGS. 2 to 6, embodiments of a servo motor and a robotic apparatus according to the present invention, wherein FIG. 1 is a schematic perspective view illustrating the robotic apparatus;

FIG. 2 is a sectional view of an assembly for a robot including the servo motor;

FIG. 3 is an enlarged sectional view illustrating an encoder and other;

FIG. 4 is a conceptional view illustrating examples for positions in which sensors and electronic components are arranged;

FIG. 5 is an enlarged sectional view illustrating an example in which each of an input sensor and an output sensor is mounted on a first circuit board via a spacer board; and

FIG. 6 is an enlarged sectional view illustrating an example in which the output sensor is mounted on the first circuit board via the spacer board.

### DETAILED DESCRIPTION OF PREFERRED EMBODIMENTS

Hereinafter, embodiments for a servo motor and a robotic apparatus according to the present invention will be described with reference to the attached Drawings.

The embodiments as shown below illustrates an example where a robotic apparatus according to the present invention is applied to a type which is installed and used on a floor or others. However, a coverage of the robotic apparatus according to the present invention is not limited to such a type which is installed and used on a floor or others but may be applied to types which are mounted and used on a ceiling and/or a wall surface.

It is to be noted that directional terms such as “front”, “back”, “upward”, “downward”, “right”, “left” or the like are merely intended for better understanding, and the present invention is not limited to such directions in its implementation.

### Schematic Structure of a Robotic Apparatus

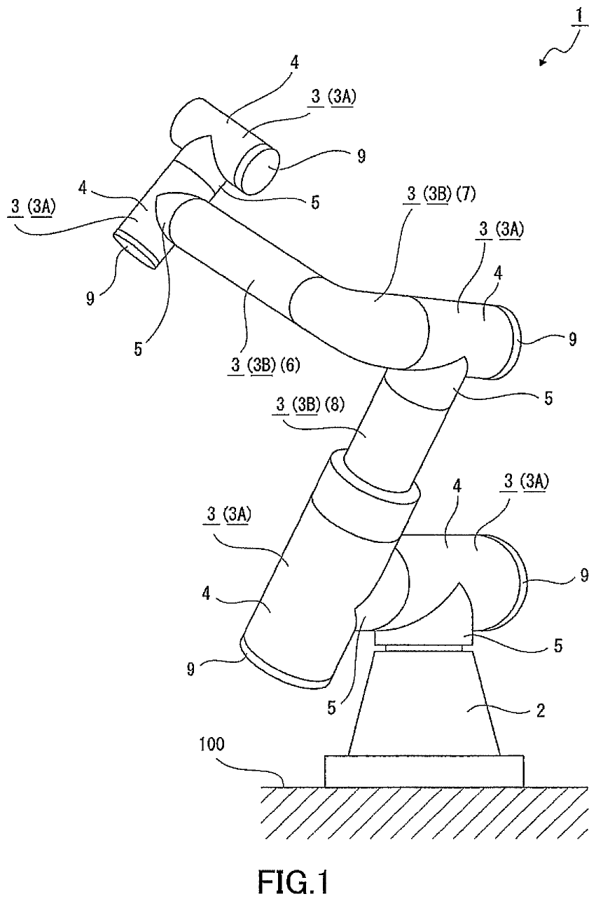

First, a schematic structure of a robotic apparatus 1 will be described (see FIG. 1). The robotic apparatus 1 has e.g., a function of transferring an object such as a box and/or goods, and is used e.g., for an application of packaging goods.

The robotic apparatus 1 includes a base 2 to be put on a floor 100 or other, and assemblies for a robot 3, 3, . . . , which are coupled in a successive manner, wherein an assembly 3 which is located at a lower end is rotatably coupled to the base 2. For example, an arm hand which is not shown is coupled to an assembly 3 located on at an upper end, wherein an object to be transferred is gripped and transferred to a predetermined position by the arm hand.

As the assemblies 3, a joint for a robot 3A or an arm for a robot 3B is used.

For example, the joint 3A has a base section 4 and a protrusion 5, wherein the base section 4 has an outer substantially cylindrical shape, and the protrusion 5 protrudes from a middle portion of the base section 4 in its axial direction in a direction orthogonal to the axial direction of the base section 4.

As the arms 3B, e.g., an arm with constant diameter 6, an elbow with varying diameter 7, and an arm with varying diameter 8 are used, wherein the arm with constant diameter 6 is formed in a substantially cylindrical shape with a constant diameter, the elbow with varying diameter 7 has a diameter varying along its axial direction and a bent shape, and a portion of the arm with varying diameter 8 has a different diameter than another portion thereof.

Here, caps 9 are attached to ends of the assemblies 3 which are not coupled to other assemblies 3 or the base 2, wherein the caps 9 close portions of the assemblies 3 which are not coupled to other assemblies 3 or the base 2.

For the robotic apparatus 1, e.g. the elbow with varying diameter 7 and/or the arm with varying diameter 8 enable that in the assemblies 3, 3, . . . coupled in a successive manner as described above, the joint 3A (upper joint) on a tip side has a smaller size than the joint 3A (lower joint) on a base end side. Accordingly, the elbow with varying diameter 7 and/or the arm with varying diameter 8 may enable the robotic apparatus 1 to be reduced in its size and weight while increasing an operation velocity due to the reduction in the weight.

### Structure of an Assembly for a Robot

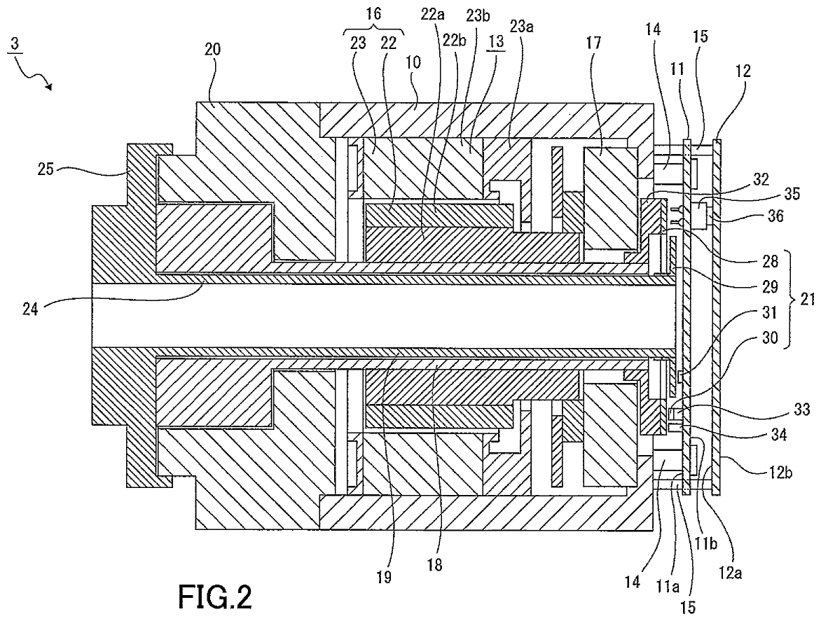

Hereinafter, an example for a structure of the assembly for a robot 3 will be described (see FIGS. 2 to 4).

The assembly 3 includes a substantially cylindrical housing 10, a first circuit board 11 attached to the housing 10, a second circuit board 12 opposed to the first circuit board 11, and a servo motor 13, wherein the servo motor 13 is partially arranged within the housing 10 (see FIG. 2).

A fixed body 20 is coupled to an axial end of the housing 10, for example by means of a fixture bolt which is not shown.

The first circuit board 11 and the second circuit board 12 have e.g. a substantially circular outer shape. Predetermined circuit patterns are formed on both opposed surfaces of each of the first circuit board 11 and the second circuit board 12. The first circuit board 11 and the second circuit board 12 are connected to a power supply which is not shown.

A surface of the first circuit board 11 opposite to a surface thereof facing the second circuit board 12 is configured as a first mounting surface 11a, wherein the surface of the first circuit board 11 facing the second circuit board 12 is configured as a second mounting surface 11b. A surface of the second circuit board 12 facing the first circuit board 11 is configured as a first mounting surface 12a, wherein a surface of the second circuit board 12 opposite to the surface of facing the first circuit board 11 is configured as a second mounting surface 12b.

The first circuit board 11 is attached to the housing 10 by the first attachment pins 14, 14, . . . , and the second circuit board 12 is attached to the housing 10 by the second attachment pins 15, 15, . . . , wherein the first circuit board 11 and the second circuit board 12 is located outside the housing 10 in an axial direction of the housing 10. The second circuit board 12 is located on an opposite side to the housing 10 with respect to the first circuit board 11 and connected to the first circuit board 11 by means of a connection terminal and a connector which will be described below.

It is to be noted that a cap 9 may be attached to the housing 10 to cover the first circuit board 11 and the second circuit board 12 by the cap 9.

The servo motor 13 has a driving section 16, a brake 17, an input shaft 18, an output shaft 19 and an encoder 21.

The driving section 16 is arranged within the housing 10 and formed with a rotor 22 and a stator 23, wherein the stator 23 is disposed on an outer circumferential side of the rotor 22. The rotor 22 includes a substantially cylindrical base tubular portion 22a and a magnet 22b attached to an outer circumferential surface of the base tubular portion 22a. The stator 23 has a substantially cylindrical coil holder 23a and a plurality of coils 23b held by the coil holder 23a, wherein the coils 23b are spaced circumferentially and facing the magnet 22b.

When the coils 23b are energized in the driving section 16, the rotor 22 is rotated relative to the stator 23 in a direction which depends on a direction of energization of the coils 23.

The brake 17 is arranged within the housing 10 and formed in an annular shape. The brake 17 has a function of stopping rotation of the rotor 22. Stopping rotation of the rotor 22 by the brake 17 prevents overrotation of the rotor 22 due to inertia, which ensures a correct rotation state of the rotor 22.

The input shaft 18 is formed in a substantially cylindrical shape and arranged within the housing 10 except for one axial end of the input shaft 18, wherein this axial end of the input shaft 18 protrudes from the housing 10. The input shaft 18 is partially positioned within the rotor 22, and the portion of the input shaft 18 positioned within the rotor 22 is coupled to the base tubular portion 22a of the rotor 22. In this manner, a driving force of the driving section 16 is transferred to the input shaft 18.

A bearing (not shown) is arranged between the housing 10 and the input shaft 18, wherein the input shaft 18 is integral with the rotor 22 via the bearing and rotated with rotor 22 relative to the housing 10.

The output shaft 19 includes a center tubular portion 24 formed in a cylindrical shape, and a force receiving portion 25 having a flange shape, wherein the force receiving portion 25 overhangs outwardly from an axial end of the center tubular portion 24, and the center tubular portion 24 is partially arranged within the input shaft 18. The center tubular portion 24 of the output shaft 19 has a larger axial length than an axial length of the input shaft 18, and a portion of the center tubular portion 24 protrudes axially from the input shaft 18, wherein the force receiving portion 25 and a portion of the center tubular portion 24 are located outside the housing 10.

A bearing (not shown) is arranged between input shaft 18 and the output shaft 19, wherein the output shaft 19 is rotatable relative to input shaft 18 via the bearing.

Another axial end of the input shaft 18 is configured as an input attachment portion 26 at an outer circumferential surface of the input shaft 18, wherein another axial end of the output shaft 19 is configured as an output attachment portion 27 at an outer circumferential surface of the output shaft 19. Both of the input attachment portion 26 and output attachment portion 27 has a constant diameter in the axial direction. Thus, the other end of the input shaft 18 and the other end of the center tubular portion 24 do not have a protrusion portion which protrudes outwardly.

A reduction gear is arranged within the fixed body 20, wherein the reduction gear has the functions of reducing a rotational speed of the input shaft 18 and outputting the driving force to the output shaft 19, the driving force having been transferred to the input shaft 18 from the driving section 16. In this manner, the driving force of the driving section 16 is transferred to the output shaft 19 via the input shaft 18 and the reduction gear, and the output shaft 19 is rotated at a lower speed as compared to the rotational speed of the input shaft 18.

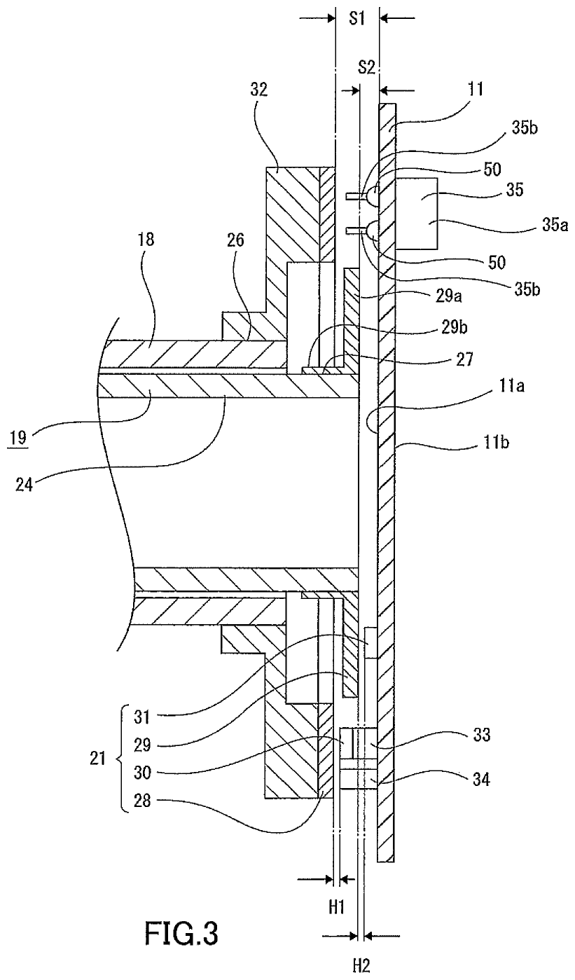

The encoder 21 has an input encoder disc 28, an output encoder disc 29, an input sensor 30 and an output sensor 31 (see FIGS. 2 and 3).

The input encoder disc 28 is formed in an annular shape and has a thickness direction which is coincident with the axial direction of the input shaft 18. For example, the input encoder disc 28 includes a plurality of magnets which are not shown. The input encoder disc 28 is attached to the input attachment portion 26 of the input shaft 18 via a disc hub 32.

The output encoder disc 29 includes an opposed surface portion 29a and a cylindrical attached portion 29b, wherein the opposed surface portion 29a is formed in an annular shape with a smaller diameter than the input encoder disc 28 and the attached portion 29b protrudes from an inner circumferential portion of the opposed surface portion 29a. For example, the output encoder disc 29 includes a plurality of magnets at the opposed surface portion 29a which are not shown. The output encoder disc 29 has a thickness direction which is coincident with the axial direction of the output shaft 19. The attached portion 29b is attached to the output attachment portion 27 of the output shaft 19.

Since the output shaft 19 protrudes axially from the input shaft 18 at the other axial end of the center tubular portion 24, the input encoder disc 28 attached to the input shaft 18 and the output encoder disc 29 attached to the output shaft 19 are located in different positions in the thickness direction.

The input encoder disc 28 is attached to the input shaft 18 with the input attachment portion 26 being inserted through the disc hub 32. Here, due to the constant diameter of the input attachment portion 26 in the axial direction as described above, the position on the input shaft 18 in which the input encoder disc 28 is attached to can be adjusted by moving the disc hub 32 axially relative to the input attachment portion 26 in an appropriate manner.

Furthermore, the output encoder disc 29 is attached to the output shaft 19 with the output attachment portion 27 being inserted through the output encoder disc 29. Here, due to the constant diameter of the output attachment portion 27 in the axial direction as described above, the position on the output shaft 19 in which the output encoder disc 29 is attached to can be adjusted by moving the output encoder disc 29 axially relative to the output attachment portion 27 in an appropriate manner.

In this manner, it is possible to adjust the axial positions on the input attachment portion 26 and output attachment portion 27 which the input encoder disc 28 and output encoder disc 29 are attached to respectively, which enables a distance between the input encoder disc 28 and the input sensor 30 as well as a distance between the output encoder disc 29 and the output sensor 31 to be adjusted as appropriate and may thus enable the flexibility of design to be improved.

In the case where it is possible to adjust the axial positions on the input attachment portion 26 and output attachment portion 27 which the input encoder disc 28 and output encoder disc 29 are attached to respectively, it is to be noted that position limiting portions such as stopper protrusions are preferably provided at the outer circumferential portions of the input attachment portion 26 and output attachment portion 27.

With such position limiting portions, a position of the disc hub 32 relative to the input attachment portion 26 and a position of the output encoder disc 29 relative to the output attachment portion 27 are limited within a predetermined range during position adjustment, so that it is possible to avoid contact of the disc hub 32 e.g. with the reduction gear and contact of the output encoder disc 29 e.g. with the input shaft 18 and to ensure correct positions of the input encoder disc 28 and output encoder disc 29.

It is to be noted that the servo motor 13 may be configured such that it is possible to adjust one of the axial positions on the input attachment portion 26 and the output attachment portion 27 which the input encoder disc 28 and the output encoder disc 29 are attached to.

Both of the input sensor 30 and the output sensor 31 are mounted on the first mounting surface 11a of the first circuit board 11. The input sensor 30 is mounted on the first circuit board 11 via a spacer board 33, wherein the spacer board 33 functions as an auxiliary board and is electrically connected to the first circuit board 11. In this manner, the input sensor 30 is supplied with power from the power supply via the spacer board 33 and the first circuit board 11, wherein signals are transmitted and received between the input sensor 30 and the first circuit board 11 via the spacer board 33.

The input sensor 30 is oriented toward the input encoder disc 28, wherein the output sensor 31 is oriented toward the output encoder disc 29.

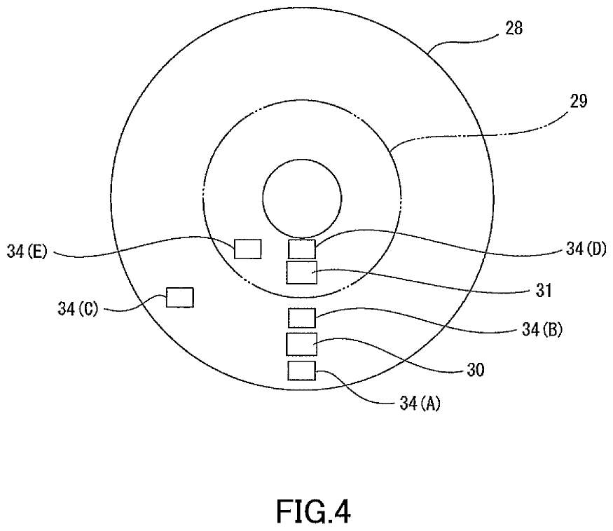

The input sensor 30 and output sensor 31 are mounted on the first mounting surface 11a, for example in positions aligned radially or spaced radially, and spaced or aligned radially with respect to a center of rotation of the input shaft 18 (see FIG. 4).

In this manner, it is possible to mount the input sensor 30 and output sensor 31 in positions on the first circuit board 11 which are in vicinity of each other so that circuit patterns connected to the input sensor 30 and output sensor 31 can be formed in concentrated positions, which may enable simplification and miniaturization of the configuration of the first circuit board 11. Furthermore, since it is possible to mount the input sensor 30 and output sensor 31 in positions on the first circuit board 11 which are in vicinity of each other, this may enable reduction in noise by reduction of wiring paths.

It is to be noted that the input sensor 30 and the output sensor 31 may be mounted in any positions on the first mounting surface 11a which are oriented toward the input encoder disc 28 and output encoder disc 29 respectively.

As described above, the servo motor 13 is configured such that the input sensor 30 is mounted on the first circuit board 11 via the spacer board 33, and a distance S1 between the first mounting surface 11a of the first circuit board 11 and the input encoder disc 28 is larger than a distance S2 between the first mounting surface 11a of the first circuit board 11 and the output encoder disc 29, wherein a distance H1 between the input sensor 30 and the input encoder disc 28 is equal to a distance H2 between the output sensor 31 and the output encoder disc 29 (see FIG. 3). In this manner, a larger space exists between the first circuit board 11 and the input encoder disc 28 than a space between the first circuit board 11 and the output encoder disc 29.

Because of the larger space between the first circuit board 11 and the input encoder disc 28 as described above, electronic components 34, 34, . . . with a large height are arranged in the larger space. For example, the electronic components 34 are a central processing unit CPU connected to the input sensor 30 and output sensor 31 and/or EEPROM (Electrically Erasable Programmable Read-Only Memory) which is non-volatile memory, wherein these electronic components 34, 34, . . . are mounted together with the input sensor 30 and output sensor 31 on the first mounting surface 11a of the first circuit board 11 (see FIG. 4).

For example, the electronic components 34 are arranged together with the input sensor 30 and output sensor 31 on the first mounting surface 11a in positions aligned radially or spaced radially, and spaced or aligned radially with respect to a center of rotation of the input shaft 18 (see 34(A) and 34(B) in FIG. 4).

In this manner, it is possible to mount the input sensor 30, output sensor 31 and electronic components 34 in positions on the first circuit board 11 which are in vicinity of each other so that circuit patterns connected to the input sensor 30, output sensor 31 and electronic components 34 can be formed in concentrated positions, which may enable further simplification and further miniaturization of the configuration of the first circuit board 11. Furthermore, since it is possible to mount the input sensor 30, output sensor 31 and electronic components 34 in positions on the first circuit board 11 which are in vicinity of each other, this may enable reduction in noise by reduction of wiring paths.

It is to be noted that the electronic components 34, 34, . . . may be mounted in any positions on the first mounting surface 11a.

It is to be noted that the electronic components 34 may be arranged in positions which are spaced circumferentially from the input sensor 30 and output sensor 31 (see 34(C) in FIG. 4). However, since it is desirable that wiring paths between the electronic components 34, input sensor 30 and output sensor 31 are short, it is desirable that the electronic components 34 are arranged in vicinity of the input sensor 30 and output sensor 31 also in the case of the electronic components 34 being spaced circumferentially from the input sensor 30 and output sensor 31.

Furthermore, when the electronic components 34 has a small height, the electronic components 34 may be also arranged in the space between the first circuit board 11 and the output encoder disc 29 (see 34(D) and 34(E) in FIG. 4). Also in this case, it is desirable that wiring paths between the electronic components 34, input sensor 30 and output sensor 31 are short, and it is therefore desirable that the electronic components 34 are arranged in vicinity of the input sensor 30 and output sensor 31.

A connection terminal 35 is mounted on the first circuit board 11 (see FIGS. 2 and 3). The connection terminal 35 is for example a component of a type, called DIP (Dual Inline Package) component, which is joined to a board with a terminal portion of the connection terminal extending through the board, e.g., by means of soldering. The connection terminal 35 includes a terminal main body 35a and terminal portions 35b, 35b. The terminal main body 35a is mounted on the second mounting surface 11b of the first circuit board 11, and the terminal portions 35b, 35b extend through the first circuit board 11, wherein the connection terminal 35 is then joined on the first mounting surface 11a by means of soldering 50, 50.

The terminal portions 35b, 35b of the connection terminal 35 extend through the first circuit board 11, and positions on the first circuit board 11 which the terminal portions 35b, 35b are mounted in are defined such that the terminal portions 35b, 35b exist in a large space formed between the first circuit board 11 and the input encoder disc 28. In this manner, the connection terminal 35 is mounted in a position where the terminal portions 35b, 35b are opposed to the input encoder disc 28.

As described above, the servo motor 13 is configured such that the input sensor 30 is mounted on the first circuit board 11 via the spacer board 33 to form a large space between the first circuit board 11 and the input encoder disc 28, wherein the terminal portions 35b, 35b of the connection terminal 35 is positioned in this space. In this manner, it is possible to mount the connection terminal 35 on the first circuit board 11 without interference of the terminal portions 35b, 35b with other elements.

Therefore, the connection terminal 35 is joined to the first circuit board 11 with a higher joint strength as compared with using a surface mount type component as the connection terminal so that a stabler joint state is ensured, which may enable reliability relating the joint of the connection terminal 35 to the first circuit board 11 to be increased.

A connector 36 is mounted on the first mounting surface 12a of the second circuit board 12. The connector 36 is connected to the terminal main body 35a of the connection terminal 35. In this manner, the second circuit board 12 is connected to the first circuit board 11 via the connection terminal 35 and the connector 36.

It is to be noted that the servo motor 13 may be miniaturized in its radial direction by providing two boards, i.e., the first circuit board 11 and second circuit board 12, and by arranging the first circuit board 11 and second circuit board 12 opposed to each other in the thickness direction, wherein a large mounting area is ensured for the electronic components at the same time, as described above.

Furthermore, in addition to the input sensor 30, output sensor 31 and electronic components 34, 34, . . . being mounted on the first circuit board 11, the electronic components 34, 34, . . . include a component which forms a driver circuit at least partially, the driver circuit being configured to drive the driving section 16.

In this manner, since in addition to the input sensor 30 and output sensor 31 being mounted on the first circuit board 11, the electronic components 34, 34, . . . include a component which forms the driver circuit at least partially, the component which forms the driver circuit at least partially is mounted on a board with the input sensor 30 and output sensor 31 mounted thereon so that fewer boards may be required for implementing the driver circuit, which may enable simplification and miniaturization of the structure.

### Other Examples for Configuration of the Sensors

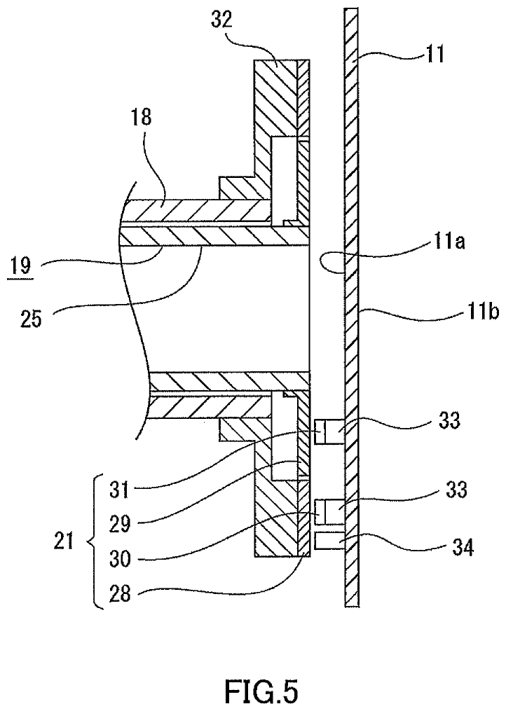

The above description has shown the example with the input sensor 30 being mounted on the first circuit board 11 via the spacer board 33. However, for example, both of the input sensor 30 and output sensor 31 may be also mounted on the first circuit board 11 via respective spacer boards 33, 33 (see FIG. 5). In this case, the input encoder disc 28 and output encoder disc 29 are arranged in the same position in the thickness direction, and large spaces exist between the first circuit board 11 and the input encoder disc 28 as well as between first circuit board 11 and the output encoder disc 29, which enable electronic components 34, 34, . . . having a large height to be arranged in these spaces.

In this manner, it is possible to increase both of the distance between the input encoder disc 28 and the first circuit board 11 and the distance between the output encoder disc 29 and the first circuit board 11 by mounting each of the input sensor 30 and output sensor 31 on the first circuit board 11 via the spacer board 33, 33. This enables flexibility of mounting positions for mounting electronic components 34 on the first circuit board 11 to be improved.

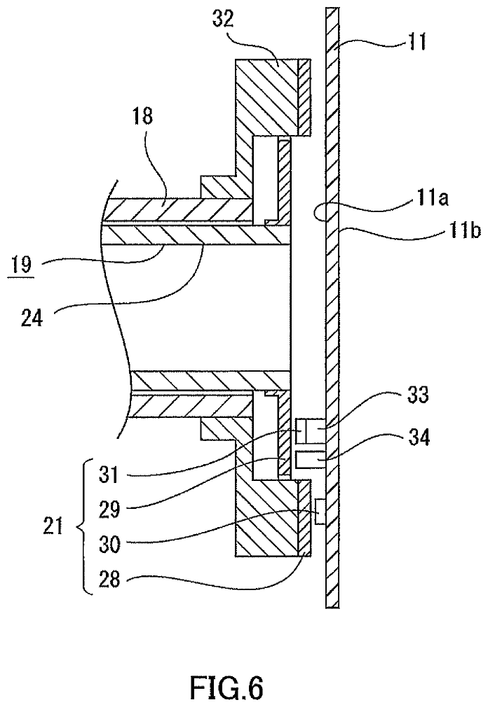

However, the output sensor 31 of the input sensor 30 and output sensor 31 may be also mounted on the first circuit board 11 via the spacer board 33 (see FIG. 6). In this case, the input encoder disc 28 and output encoder disc 29 are arranged in different positions in the thickness direction, and a large space exists between first circuit board 11 and the output encoder disc 29, which enable electronic components 34, 34, . . . having a large height to be arranged in this large space.

However, the servo motor 13 may be configured such that the input sensor 30 is mounted on the first circuit board 11 via the spacer board 33, as described above, and one of the input sensor 30 or the output sensor 31 may be also mounted on the first circuit board 11 via the spacer board 33.

In this manner, it is possible to increase the distance between one of the input encoder disc 28 or the output encoder disc 29 and the first circuit board 11 depending on an internal structure of the servo motor 13 by mounting one of the input sensor 30 or output sensor 31 on the first circuit board 11 via the spacer board 33, which enables electronic components 34, 34, . . . in correct positions on the first circuit board 11 while enabling the flexibility of design to be increased.

It is to be noted that the size (height) of the spacer board 33 may be set appropriately depending on a size (height) of the input sensor 30 or output sensor 31 to be mounted on the first circuit board 11.

By arranging the spacer board 33, the distance between the input sensor 30 and the input encoder disc 28 or the distance between the output sensor 31 and the output encoder disc 29 may vary depending on the height of the spacer board 33. However, it is possible to set a correct distance between the input sensor 30 and the input encoder disc 28 or between the output sensor 31 and the output encoder disc 29 by setting the axial position of the input encoder disc 28 or output encoder disc 29 as appropriate and/or by adjusting the axial position during assembling each of the components.

### Summary

As described above, the servo motor 13 and the robotic apparatus 1 including the servo motor 13 include the circuit board (first circuit board 11) including a predetermined circuit pattern; the input sensor 30 mounted on the circuit board, wherein the input sensor is oriented toward the input encoder disc 28; and the output sensor 31 mounted on the circuit board, wherein the output sensor is oriented toward the output encoder disc 29; wherein at least one of the input sensor 30 or the output sensor 31 is mounted on the circuit board via the spacer board 33, the spacer board being connected to the circuit board, and wherein the electronic component 34 is mounted on the circuit board.

In this manner, at least one of the distance between the input encoder disc 28 and the input sensor 30 or the distance between the output encoder disc 29 and the output sensor 31 is increased by an amount corresponding to positioning the spacer board 33, whereby limitations to sizes (heights) of electronic components 34 which are mountable to the circuit board may be caused with less likelihood, which may enable improved flexibility of design and miniaturization to be achieved.

Furthermore, it is possible to arrange electronic components 34 to be connected to the input sensor 30 and output sensor 31 in the enlarged space and to thus allow the wiring paths for connecting the input sensor 30, output sensor 31 and electronic components 34 to be shortened, whereby occurrence of noise can be suppressed and the reliability of operation may be increased.

### Others

Although the example has been shown above in which the servo motor 13 includes the magnetic encoder 21 which includes the input encoder disc 28, output encoder disc 29, input sensor 30 and output sensor 31, the encoder in the servo motor 13 is not limited to a magnetic encoder, but an optical encoder, an encoder with electromagnetic induction, or a capacitive encoder may be also provided in the servo motor 13.

### Reference Signs List

1 Robotic apparatus
11 First circuit board
15 Servo motor
16 Driving section
18 Input shaft
19 Output shaft
21 Encoder
22 Rotor
23 Stator
28 Input encoder disc
29 Output encoder disc
30 Input sensor
31 Output sensor
33 Spacer board
34 Electronic components

1. A servo motor comprising:
a driving section including a rotor and stator;
an input shaft configured such that a driving force of the driving section is transferred to the input shaft, wherein the input shaft is configured to be integral and rotated with the rotor;
a reduction gear configured to output the driving force from the input shaft by reducing a rotational speed of the input shaft;
an output shaft configured such that the driving force which has been transferred to the input shaft is transferred to the output shaft via the reduction gear;
an input encoder disc attached to the input shaft;
an output encoder disc attached to the output shaft;
a circuit board including a predetermined circuit pattern;
an input sensor mounted on the circuit board, wherein the input sensor is oriented toward the input encoder disc; and
an output sensor mounted on the circuit board, wherein the output sensor is oriented toward the output encoder disc;
wherein at least one of the input sensor or the output sensor is mounted on the circuit board via a spacer board, the spacer board being connected to the circuit board, and
wherein an electronic component is mounted on the circuit board, the electronic component being different from the input sensor and output sensor.

2. The servo motor according to claim 1,
wherein one of the input sensor or the output sensor is mounted on the circuit board via the spacer board.

3. The servo motor according to claim 1,
wherein each of the input sensor and the output sensor is mounted on the circuit board via the spacer board.

4. The servo motor according to claim 1,
wherein the input sensor and the output sensor are spaced or aligned radially with respect to a center of rotation of the input shaft.

5. The servo motor according to claim 4,
wherein the electronic component, the input sensor and the output sensor are spaced or aligned radially with respect to a center of rotation of the input shaft.

6. The servo motor according to claim 1,
wherein the electronic component includes a component which forms a driver circuit at least partially, the driver circuit being configured to drive the driving section.

7. The servo motor according to claim 1,
wherein a portion of an outer circumferential surface of the input shaft is configured as an input attachment portion to which the input encoder disc is attached,
wherein a portion of an outer circumferential surface of the output shaft is configured as output attachment portion to which the output encoder disc is attached, and
wherein at least one of the input attachment portion or the output attachment portion has a constant diameter in an axial direction.

8. A robotic apparatus comprising:
a plurality of assemblies for a robot; and
a servo motor at at least one of the assemblies, the servo motor including:
a driving section including a rotor and stator;
an input shaft configured such that a driving force of the driving section is transferred to the input shaft, wherein the input shaft is configured to be integral and rotated with the rotor;
a reduction gear configured to output the driving force from the input shaft by reducing a rotational speed of the input shaft;
an output shaft configured such that the driving force which has been transferred to the input shaft is transferred to the output shaft via the reduction gear;
an input encoder disc attached to the input shaft;
an output encoder disc attached to the output shaft;
a circuit board including a predetermined circuit pattern;
an input sensor mounted on the circuit board, wherein the input sensor is oriented toward the input encoder disc; and
an output sensor mounted on the circuit board, wherein the output sensor is oriented toward the output encoder disc;
wherein at least one of the input sensor or the output sensor is mounted on the circuit board via a spacer board, the spacer board being connected to the circuit board, and
wherein an electronic component is mounted on the circuit board, the electronic component being different from the input sensor and output sensor.

9. The servo motor according to claim 2,
wherein the input sensor and the output sensor are spaced or aligned radially with respect to a center of rotation of the input shaft.

10. The servo motor according to claim 3,
wherein the input sensor and the output sensor are spaced or aligned radially with respect to a center of rotation of the input shaft.

11. The servo motor according to claim 9,
wherein the electronic component, the input sensor and the output sensor are spaced or aligned radially with respect to a center of rotation of the input shaft.

12. The servo motor according to claim 10,
wherein the electronic component, the input sensor and the output sensor are spaced or aligned radially with respect to a center of rotation of the input shaft.

13. The servo motor according to claim 2,
wherein the electronic component includes a component which forms a driver circuit at least partially, the driver circuit being configured to drive the driving section.

14. The servo motor according to claim 3,
wherein the electronic component includes a component which forms a driver circuit at least partially, the driver circuit being configured to drive the driving section.

15. The servo motor according to claim 4,
wherein the electronic component includes a component which forms a driver circuit at least partially, the driver circuit being configured to drive the driving section.

16. The servo motor according to claim 5,
wherein the electronic component includes a component which forms a driver circuit at least partially, the driver circuit being configured to drive the driving section.
